(19) United States
(12) Patent Application Publication
(10) Pub. No.: US 2003/0152413 A1
(43) Pub. Date: Aug. 14, 2003

(54) Rolling applicator tool

(76) Inventor: Ronald Al Marks, Bakersfield, CA (US)

Correspondence Address: KLEIN, DENARALE, GOLDNER, COOPER, ROSENLIEB &, KIMBALL LLP., P.O. BOX 11172, 4550 CALIFORNIAA AVE., SECOND FLOOR, BAKERFEILD, CA, 93309, US

(21) Appl. No.: 10/071,532

(22) Filed: Feb. 8, 2002

(51) Int. Cl. B05C 21/00; B05C 17/03

(52) U.S. Cl. 401/197; 401/208

(57) ABSTRACT

A method and apparatus to apply wax or solutions to cars, car tires, car seats, walls, floors, and the human body using a rolling brush or gloved mitten so that when you either push the roller brush or gloved mitten against a surface or roll the rolling brush against a surface or compress a hand squeeze type pump, a solution is pushed to the rolling brush or hand mitten. The apparatus is made connected to the roller brush and container, hand mitten and container or can be made as a tool to be attached to many product containers. It consist of a cylindrical brush or hand mitten, a pump device, a pipe system that delivers a solution to the roller brush or hand mitten, a cap that can be screwed onto various product containers. Also a hollow connecting tube is used to extend the length of function.

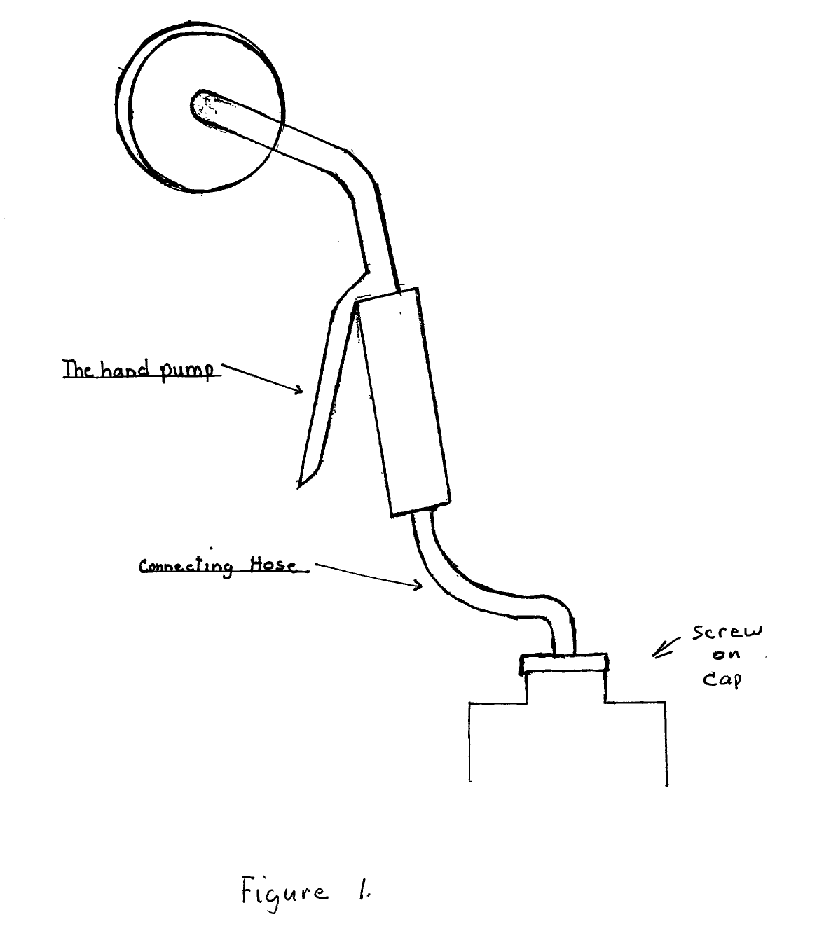

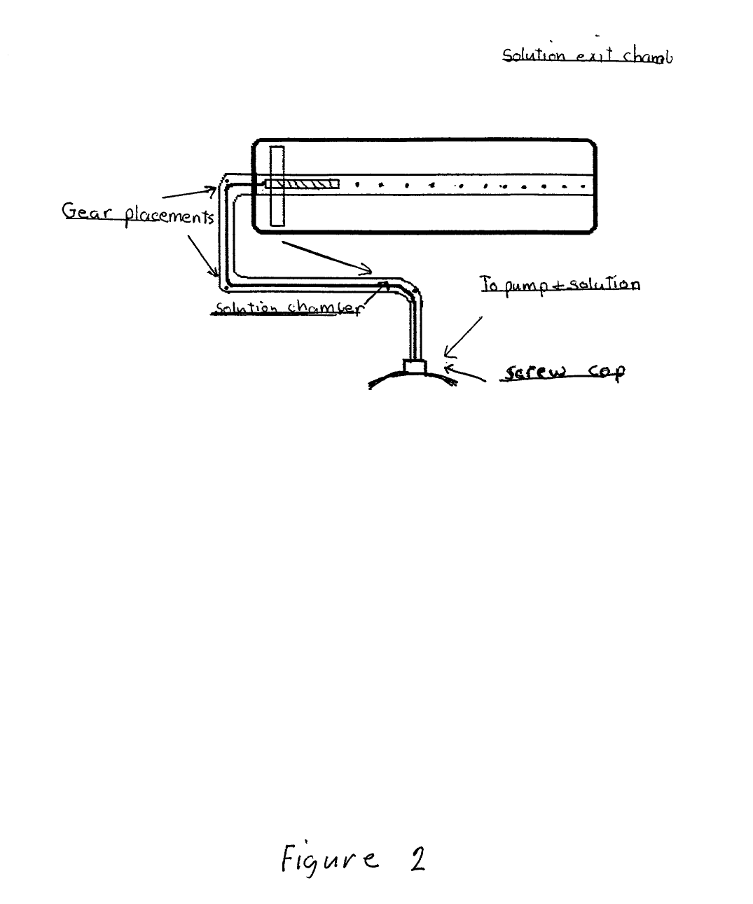

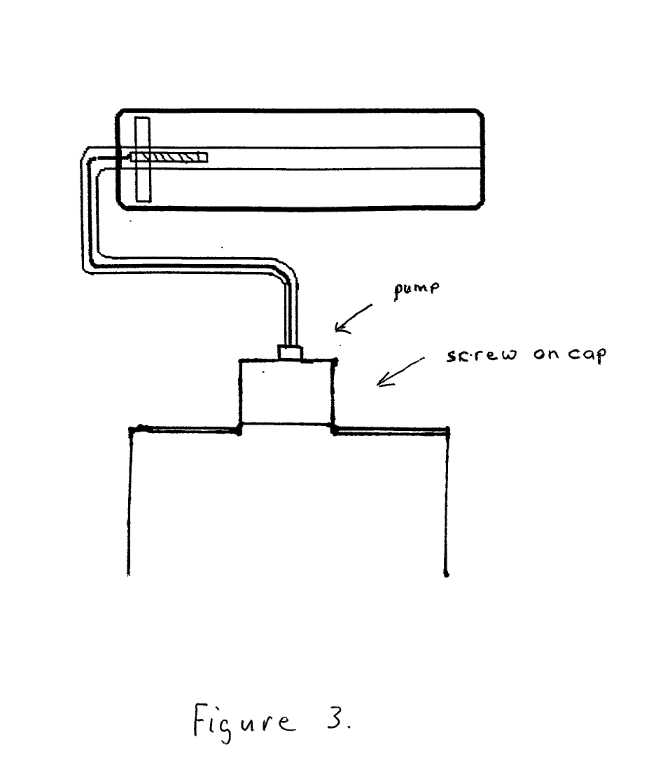

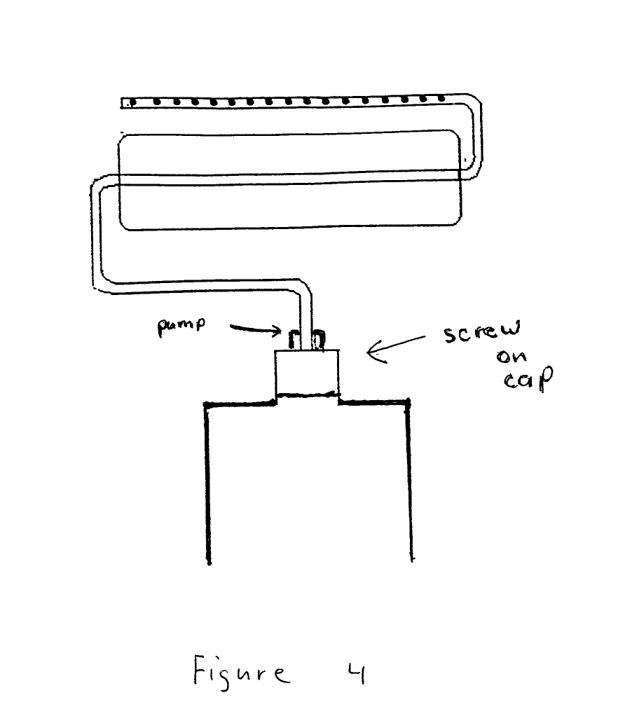

### BACKGROUND OF INVENTION

When applying solutions, paint to surfaces, in most cases, a absorbent material is required and is wiped or sprayed onto the surface. In some instances, the solution is poured to a second container for applications. The intent of this invention is to have a tool that is applied to a solution container that will pump the solution from the container into a rolling type applicator or in close proximity to the applicator and also the solution is pumped from the container as the container is rolled or pressed on the surface being used. This will allow for quicker and cleaner applications and eliminate the need for many assessory cleaning items.

### SPECIFICATIONS

A brush/sponge brush in the shape of a cylinder which houses a mechanism that when the brush is rolled against a surface it activates a pump system that will dispense liquids into the sponge brush or in close proximity to it. Also, a brush/sponge system in the shape of a cylinder which a has a pump attached to it and when the rolling system is pressed against a surface, liquids will dispense into or in close proximity to it. A system that has a hand grip that enables the user to roll the brush and/or press the brush against a surface. Also, a brush/sponge brush in the shape of a cylinder that will receive solutions or or in close proximity to it when a finger or hand activates a pump by compressing it. A screw cap is used on these systems to allow for attaching to all solution containers on todays markets. An apparatus that has a rolling brush/sponge that will receive solution in it or in close proximity to it. The solution is received by a pump activated by rolling the brush against a surface or pushing the brush against a surface or squeezing/compressing a pump with the finger/hand.

1. A apparatus that has a cap that can be screwed onto solution containers and that when pushed will push a solution into a rolling sponge/brush.

2. A apparatus that has a cap that can be screwed onto solution containers and when rolled will activate a pump that will push a solution into a rolling sponge/brush.

3. A apparatus that has a cap that can be screwed onto a solution containers and when pushed will push a solution in close proximity to a rolling sponge/brush.

4. A apparatus that has a cap that can be screwed onto a solution containers and when rolled will activate a pump that will push a solution in close proximity to a rolling brush/sponge.

5. A apparatus that has a cap that can be screwed onto solution containers to apply wax evenly onto a surface by rolling the solution on it.

6. A apparatus that has a cap that can be screwed onto solution containers with the purpose of pumping a solution from it into a glove sponge/brush by pressing it against a surface.

7. A apparatus that has a cap that can be screwed onto solution containers and that when squeezed with the hand or finger or pressed against a surface will pump a solution into a rolling brush/gloved brush.

8. A apparatus that has a cap that can be that can be attached to solution containers and has a pump that will dispense liquids into it by pressing it against a surface.
